(19) United States
(12) Patent Application Publication
(10) Pub. No.: US 2011/0241817 A1
(43) Pub. Date: Oct. 6, 2011

(54) CURRENT FUSE, SEMICONDUCTOR DEVICE, AND METHOD OF BLOWING A CURRENT FUSE

(75) Inventor: Yuuki DOI, Miyazaki (JP)

(73) Assignee: OKI SEMICONDUCTOR CO., LTD., Tokyo (JP)

(21) Appl. No.: 13/073,531

(22) Filed: Mar. 28, 2011

(30) Foreign Application Priority Data
Mar. 31, 2010 (JP) 2010-081346

(51) Int. Cl. H01H 85/02

(52) U.S. Cl. 337/290

(57) ABSTRACT

A current fuse includes: a fuse portion that is disposed on a substrate; and a conductive portion that is placed in an overlying layer above the fuse portion or an underlying layer between the substrate and the fuse portion, has the same potential as that of one portion of the fuse portion when a current is passed through the fuse portion, and extends apart from the fuse portion from the one portion side of the fuse portion as far as an overlying layer above or an underlying layer below another portion of the fuse portion whose potential differs from that of the one portion.

### CROSS-REFERENCE TO RELATED APPLICATION

This application is based on and claims priority under 35 USC 119 from Japanese Patent Application No. 2010-081346 filed on Mar. 31, 2010, the disclosure of which is incorporated by reference herein.

### BACKGROUND

1. Technical Field

The present invention relates to a current fuse, a semiconductor device, and a method of blowing a current fuse.

2. Related Art

As a conventional current fuse, there is known a current fuse equipped with a fuse portion including a single-layer conductor on the surface of an insulating substrate as described, for example, in Japanese Patent Application Laid-Open (JP-A) No. 2003-151425 and JP-A No. 2003-173728.

FIG. 10A is a diagram showing a top view of a current fuse equipped with the same conventional configuration as in JP-A No. 2003-151425. A conventional current fuse 500 is equipped with a fuse portion 502 such as described above on an unillustrated insulating substrate. This fuse portion 502 has a fuse element 504 that melts when an overcurrent flows through it.

The fuse element 504 has a slender rectangular shape when seen in a top view, and a first joint portion 506 is connected to one lengthwise direction end portion thereof. The first joint portion 506 is connected to a first terminal portion 510 electrically connected to a ground 508 and joins together the fuse element 504 and the first terminal portion 510. Further, a second joint portion 512 is connected to the other lengthwise direction end portion of the fuse element 504. The second joint portion 512 is connected to a second terminal portion 516 electrically connected to an applying portion 514 that applies a 10 V voltage, for example, and the second joint portion 512 joins together the fuse element 504 and the second terminal portion 516.

In this current fuse 500, when a current is passed through the fuse portion 502, as shown in FIG. 10B, the equipotential lines in the fuse element 504 are formed at equal intervals and the electric field is made uniform.

However, in this conventional configuration, it has been necessary to perform optimization of the optimum blow voltage (current) in order to prevent (the fuse element 504 of) the fuse portion 502 from not blowing in a case where an overcurrent flows through the fuse portion 502, so extracting the conditions of that optimization has taken time.

### SUMMARY

In view of the above-described circumstances, it is an object of the present invention to provide a current fuse, a semiconductor device, and a method of blowing a current fuse with which a fuse portion can be easily blown.

A current fuse pertaining to a first aspect of the invention includes: a fuse portion that is disposed on a substrate; and a conductive portion that is placed in an overlying layer above the fuse portion or an underlying layer between the substrate and the fuse portion, has the same potential as that of one portion of the fuse portion when a current is passed through the fuse portion, and extends apart from the fuse portion from the one portion side of the fuse portion as far as an overlying layer above or an underlying layer below another portion of the fuse portion whose potential differs from that of the one portion.

According to this configuration, the current fuse is equipped with the conductive portion that has the same potential as that of one portion of the fuse portion and extends apart from the fuse portion from the one portion side of the fuse portion as far as the overlying layer above or the underlying layer below the other portion of the fuse portion whose potential differs from that of the one portion. For this reason, the electric field concentrates in the other portion. As a result of this, when an overcurrent flows through the fuse portion, the current density becomes locally high and the Joule heat becomes higher at the other portion where the electric field concentrates, and the fuse portion can be easily blown (melted) at the other portion.

The phrase “the electric field concentrates” refers to the equipotential lines concentrating and the electric field becoming stronger.

A current fuse pertaining to a second aspect of the invention is the current fuse pertaining to the first aspect, further including a connecting portion that extends from the one portion of the fuse portion to the overlying layer or the underlying layer and electrically interconnects the one portion of the fuse portion and the conductive portion.

In this way, because the one portion of the fuse portion and the conductive portion are electrically interconnected via the connecting portion, the conductive portion can be given the same potential as that of the one portion of the fuse portion.

A current fuse pertaining to a third aspect of the invention is the current fuse pertaining to the first aspect or the second aspect, wherein the other portion of the fuse portion has a higher potential than that of the one portion of the fuse portion.

According to this configuration, the conductive portion extends from the one portion side of the fuse portion as far as the other portion side whose potential is higher than that of the one portion.

A current fuse pertaining to a fourth aspect of the invention is the current fuse pertaining to the third aspect, wherein the fuse portion has a first terminal portion on a ground side, a second terminal portion on an applying side, and a fuse element connected to both of the terminal portions, the connecting portion is connected to the first terminal portion, and the conductive portion extends from the first terminal portion side as far as an overlying layer above or an underlying layer below an intermediate section of the fuse element.

According to this configuration, the electric field from the second terminal portion as far as the intermediate section of the fuse element can be concentrated in the other portion of the fuse portion (the intermediate section of the fuse element), and the fuse portion can be more easily blown (melted) at the intermediate section.

A current fuse pertaining to a fifth aspect of the invention is the current fuse pertaining to the fourth aspect, wherein the conductive portion extends as far as the overlying layer above or the underlying layer below a midsection of the fuse element.

According to this configuration, the electric field from the second terminal portion side as far as the midsection of the fuse element can be concentrated in the other portion of the fuse portion (the midsection of the fuse element), and the fuse portion can be more easily blown (melted) at the midsection.

A current fuse pertaining to a sixth aspect of the invention is the current fuse pertaining to the second aspect, wherein the fuse portion has a first terminal portion on a ground side, a second terminal portion on an applying side, and a fuse element connected to both of the terminal portions, the connecting portion has a first connecting portion connected to the first terminal portion and a second connecting portion connected to the second terminal portion, and the conductive portion has a first conductive portion that is electrically connected to the fuse portion via the first connecting portion and extends from the first terminal portion side as far as an overlying layer above or an underlying layer below an intermediate section of the fuse element and a second conductive portion that is electrically connected to the fuse portion via the second connecting portion, extends from the second terminal portion side toward the first terminal portion side, and is apart from and opposes the first conductive portion.

According to this aspect, the electric field can be concentrated more locally in the fuse element located in the underlying layer below or the overlying layer above the place where the first conductive portion and the second conductive portion are apart.

A current fuse pertaining to a seventh aspect of the invention includes: a fuse portion that is disposed on a substrate and is configured to include a first terminal portion on a ground side, a second terminal portion on an applying side, and a fuse element connected to both of the terminal portions; and a conductive portion that is placed in an overlying layer above the fuse portion or an underlying layer between the substrate and the fuse portion, is electrically connected to the first terminal portion, and extends apart from the fuse portion from the first terminal portion side as far as an overlying layer above or an underlying layer below an intermediate section of the fuse element.

According to this configuration, the conductive portion that extends from the first terminal portion side as far as the overlying layer above or the underlying layer below the fuse element has the same potential as the potential of the first terminal portion, and the electric field concentrates in the intermediate section of the fuse element. As a result of this, when an overcurrent flows through the fuse portion, the current density becomes locally high and the Joule heat becomes higher at the intermediate section of the fuse element where the electric field concentrates, and the fuse portion can be easily blown (melted) at the intermediate section of the fuse element.

A current fuse pertaining to an eighth aspect of the invention is the current fuse pertaining to any one of the fifth to seventh aspects, wherein the width of the fuse element is narrower than the widths of both of the terminal portions.

According to this configuration, the electric field becomes stronger in the fuse element and the fuse portion blows.

A current fuse pertaining to a ninth aspect of the invention is the current fuse pertaining to any one of the fourth to eighth aspects, wherein the width of the conductive portion is longer than the width of the fuse element.

According to this configuration, the width of the conductive portion is longer than the width of the fuse element, so it becomes possible to realize more reliable blowing of the fuse portion because the electric field concentrates in the entire transverse width of the fuse element.

A current fuse pertaining to a tenth aspect of the invention is the current fuse pertaining to any one of the fourth to ninth aspects, wherein the fuse element has two first fuse elements that are connected to respectively different places of the second terminal portion serving as the applying side and extend from the second terminal portion toward the first terminal portion, a joint portion at which the two first fuse elements join together, and a second fuse element that extends from the joint portion to the first terminal portion, and the conductive portion electrically connected to the first terminal portion extends as far as an overlying layer above or an underlying layer below an intermediate section of the second fuse element.

According to this configuration, in a case where the same amount of current flows through the two first fuse elements respectively connected to different places of the second terminal portion, about twice the current flows through the second fuse element from the joint portion to the first terminal portion as compared to each of the first fuse elements, and the electric field concentrates in the second fuse element (the current density becomes larger). Further, because the conductive portion extends as far as the overlying layer above or the underlying layer below the intermediate section of the second fuse element, the electric field further concentrates in the intermediate section of the second fuse element through which about twice the current flows as compared to each of the first fuse elements. Consequently, the fuse portion can be more easily blown at the intermediate section of the second fuse element.

A current fuse pertaining to an eleventh aspect of the invention is the current fuse pertaining to any one of the second to tenth aspects, wherein an interlayer insulating layer is disposed between the fuse portion and the conductive portion, the connecting portion includes a conductor buried inside a hole penetrating the interlayer insulating layer, and the conductive portion is placed in an underlying layer below the fuse portion.

According to this configuration, the conductive portion is placed in the underlying layer below the fuse portion, whereby it becomes possible to prevent a situation where, for example, an unillustrated open portion is disposed above the fuse portion and, at the time when the fuse portion blows, fragments and so forth of the blown fuse portion fly inside a device to which the current fuse is attached.

Further, because the interlayer insulating layer is disposed between the fuse portion and the conductive portion, the conductive portion and the fuse portion no longer contact each other except for at the connecting portion.

A semiconductor device pertaining to a twelfth aspect of the invention includes: a semiconductor substrate; an insulating layer that is formed on the semiconductor substrate; and the current fuse pertaining to any one of the first to eleventh aspects of the invention which is formed on the insulating layer.

In this way, the current fuse can also be applied to a semiconductor device.

A method of blowing a current fuse pertaining to a thirteenth aspect of the invention is a method of blowing a current fuse where a fuse portion is disposed on a substrate, the method including placing a conductive portion having a single potential apart from the fuse portion in an overlying layer above the fuse portion or an underlying layer between the substrate and the fuse portion and utilizing the conductive portion to concentrate an electric field in one portion of the fuse portion and melt the fuse portion.

According to this blowing method, by concentrating the electric field in the one portion of the fuse portion, high Joule heat can be generated in the one portion as compared to the other portion of the fuse portion, and the one portion can be easily blown (melted).

A method of blowing a current fuse pertaining to a fourteenth aspect of the invention is the method of blowing a current fuse pertaining to the thirteenth aspect of the invention, wherein the fuse portion has a first terminal portion on a ground side, a second terminal portion on an applying side, and a fuse element connected to both of the terminal portions, and as the conductive portion, the method uses a first conductive portion that is electrically connected to the fuse portion via a first connecting portion connected to the first terminal portion and extends from the first terminal portion side as far as an overlying layer above or an underlying layer below an intermediate section of the fuse element and a second conductive portion that is electrically connected to the fuse portion via a second connecting portion connected to the second terminal portion, extends from the second terminal portion side toward the first terminal portion side, and is apart from and opposes the first conductive portion.

According to this blowing method, the electric field can be concentrated more locally in the fuse element located in the underlying layer below or the overlying layer above the place where the first conductive portion and the second conductive portion are apart as compared to the method blowing a current fuse pertaining to the thirteenth aspect.

Because the present invention is given the configuration described above, it can provide a current fuse, a semiconductor device, and a method of blowing a current fuse with which a fuse portion can be easily blown.

### BRIEF DESCRIPTION OF THE DRAWINGS

Exemplary embodiments of the present invention will be described in detail based on the following figures, wherein:

FIG. 1 is a general top view showing the structure of a current fuse pertaining to a first exemplary embodiment of the present invention;

FIG. 2 is a sectional view as seen from line A-A of FIG. 1;

FIG. 3A to FIG. 3J are diagrams showing a method of manufacturing the current fuse pertaining to the first exemplary embodiment of the present invention;

FIG. 4A is an explanatory diagram regarding a method of blowing the current fuse pertaining to the first exemplary embodiment of the present invention and is a top view of the current fuse;

FIG. 4B is a sectional view as seen from line A-A of FIG. 4A;

FIG. 5 is a general top view showing the structure of a current fuse pertaining to a second exemplary embodiment of the present invention;

FIG. 6 is a sectional view as seen from line B-B of FIG. 5;

FIG. 7A to FIG. 7J are diagrams showing a method of manufacturing the current fuse pertaining to the second exemplary embodiment of the present invention;

FIG. 8A is an explanatory diagram regarding a method of blowing the current fuse pertaining to the second exemplary embodiment of the present invention and is a top view of the current fuse;

FIG. 8B is a sectional view as seen from line B-B of FIG. 8A;

FIG. 9 is a general top view showing the structure of a current fuse pertaining to a third exemplary embodiment of the present invention;

FIG. 10A is an explanatory diagram regarding a method of blowing a conventional current fuse and is a diagram showing a top view; and

FIG. 10B is a diagram showing a sectional view of the conventional current fuse.

### DETAILED DESCRIPTION

### First Exemplary Embodiment

A current fuse, a semiconductor device, and a method of blowing a current fuse pertaining to a first exemplary embodiment of the present invention will be described below on the basis of the drawings. First, the structure of the current fuse pertaining to the first exemplary embodiment of the present invention will be described.

—Structure—

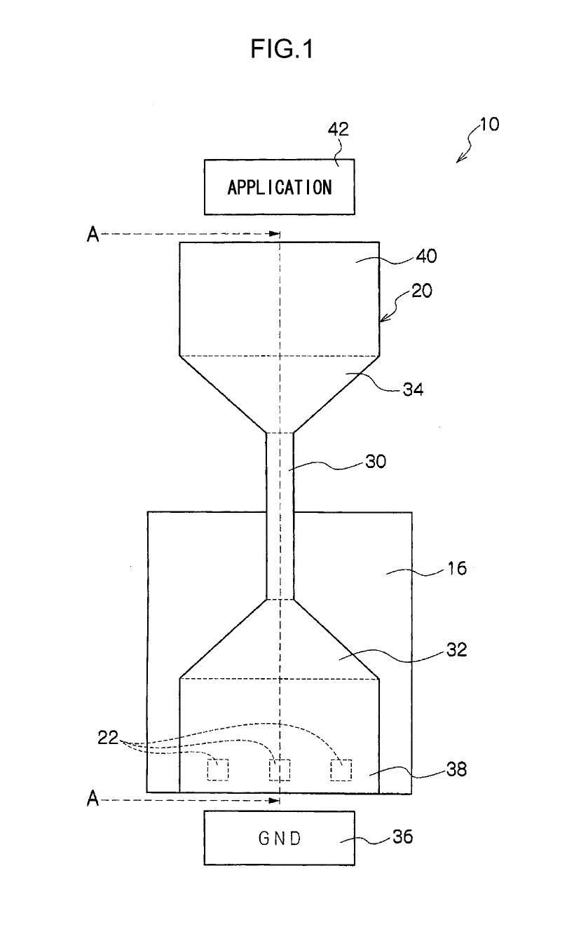

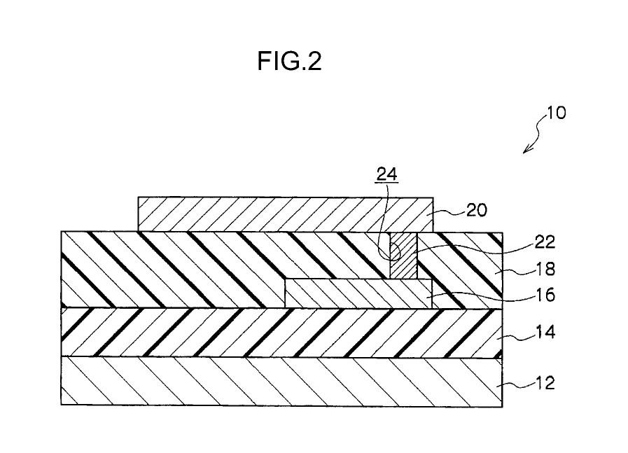

FIG. 1 is a general top view showing the structure of the current fuse pertaining to the first exemplary embodiment of the present invention, and FIG. 2 is a sectional view as seen from line A-A of FIG. 1.

As shown in FIG. 2, a current fuse 10 pertaining to the first exemplary embodiment of the present invention is configured in such a way that an insulating layer 14 including an insulator such as a BPSG (Boron Phosphor Silicate Glass) film, for example, is formed on a semiconductor substrate 12 such as a silicon wafer. A conductive portion 16 is formed on this insulating layer 14.

The conductive portion 16 includes a conductor such as AlSiCu, for example, and its upper surface is covered by an interlayer insulating layer 18 similarly formed on the insulating layer 14. This interlayer insulating layer 18 includes an insulator such as a NSG (Non-doped Silicate Glass) film or a plasma oxide film, for example, and a fuse portion 20 is formed on the interlayer insulating layer 18. This fuse portion 20 includes a conductor such as AlSiCu like the conductive portion 16, for example, and one end portion of the conductive portion 16 and one end portion of the fuse portion 20 are electrically interconnected via a connecting portion 22. This connecting portion 20 is a so-called through hole including a conductor such as copper or tungsten buried inside a hole 24 penetrating the interlayer insulating layer 18.

A protective layer including an insulator such as a plasma nitride film, for example, is disposed on the interlayer insulating layer 18 so as to cover the area surrounding the fuse portion 20. The protective layer is omitted throughout all the drawings. Further, in the present invention, “upper” refers to the direction of the fuse portion 20 using the semiconductor substrate 12 as a reference and “lower” refers to the direction of the semiconductor substrate 12 using the fuse portion 20 as a reference.

Next, the configurations of the fuse portion 20 and the conductive portion 16 will be specifically described using FIG. 1. In FIG. 1, the substrate 12 and the interlayer insulating layer 18 and so forth are omitted.

The fuse portion 20 has a fuse element 30 that melts when an overcurrent flows through it. This fuse element 30 has a slender rectangular shape when seen in a top view. The length of the fuse element 30 in its lengthwise direction is 10 μm, for example, and the length (width) of the fuse element 30 in its widthwise direction is 1.2 μm, for example.

Additionally, a first joint portion 32 is connected to one lengthwise direction end portion of the fuse element 30. Further, a second joint portion 34 is connected to the other lengthwise direction end portion of the fuse element 30. The first joint portion 32 and the second joint portion 34 (called “both of the joint portions” below) have trapezoidal shapes when seen in a top view and slant by 45 degrees toward the fuse element 30 side such that their widths gradually become narrower.

The first joint portion 32 is connected to a first terminal portion 38 electrically connected to a ground 36 and joins together the fuse element 30 and the first terminal portion 38. Further, the second joint portion 34 is connected to a second terminal portion 40 electrically connected to an applying portion 42 that applies a 10 V voltage, for example, and the second joint portion 34 joins together the fuse element 30 and the second terminal portion 40.

The widths of the first terminal portion 38 and the second terminal portion 40 (called “both of the terminal portions” below) are 6 μm, for example, and are wider than the width of the fuse element 30.

One end portion each of three, for example, of the connecting portions 22 are arranged in the width direction an interval apart from each other and contact the lower surface of the first terminal portion 38.

Each of the connecting portions 22 extends linearly downward from the lower surface of the first terminal portion 38 of the fuse portion 20, and the other end portion of each of the connecting portions 22 contacts the upper surface of the aforementioned conductive portion 16. The conductive portion 16 is placed in an underlying layer below the fuse portion 20 with the interlayer insulating layer 18 being sandwiched therebetween, has the same potential (about 0 V) as that of one portion of the fuse portion 20 (the portion of the fuse portion 20 that contacts the connecting portions 22) when a current is passed through the fuse portion 20, and extends from the one portion side of the fuse portion 20 as far as an underlying layer below another portion of the fuse portion 20 whose potential differs from that of the one portion.

Specifically, in the first exemplary embodiment, the other portion is an intermediate section of the fuse element 30—such as, for example, a midsection of the fuse element 30—whose potential is higher than that of the one portion of the fuse portion 20, and the conductive portion 16 extends linearly apart from the fuse portion 20 from the underlying layer below the portion of the fuse portion 20 that contacts the connecting portions 22 as far as the underlying layer below the midsection of the fuse element 30.

Further, the width of the conductive portion 16 is longer than the width of the fuse portion 20 and particularly the width of the fuse element 30.

—Manufacturing Method—

Next, a method of manufacturing the current fuse pertaining to the first exemplary embodiment of the present invention will be described.

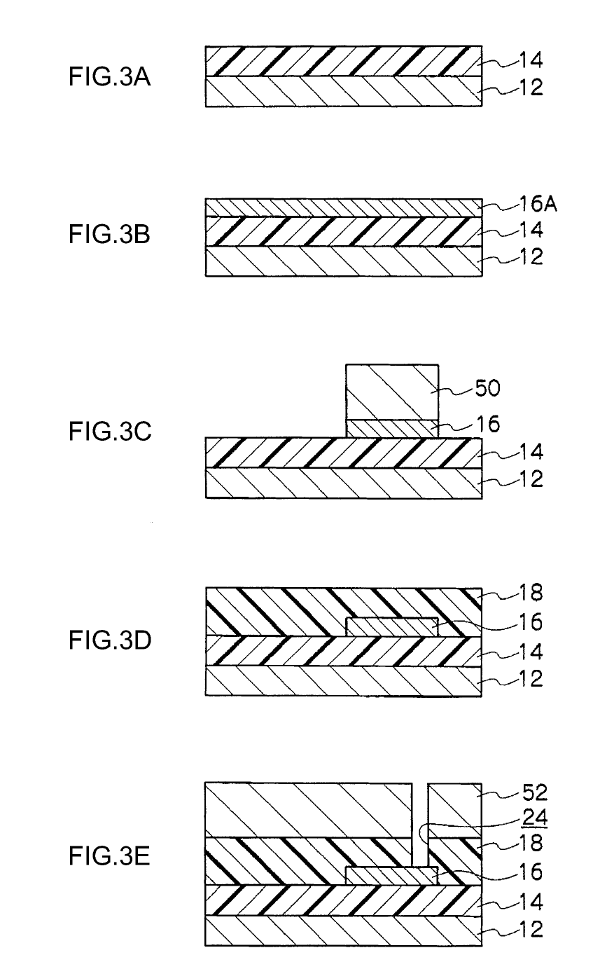

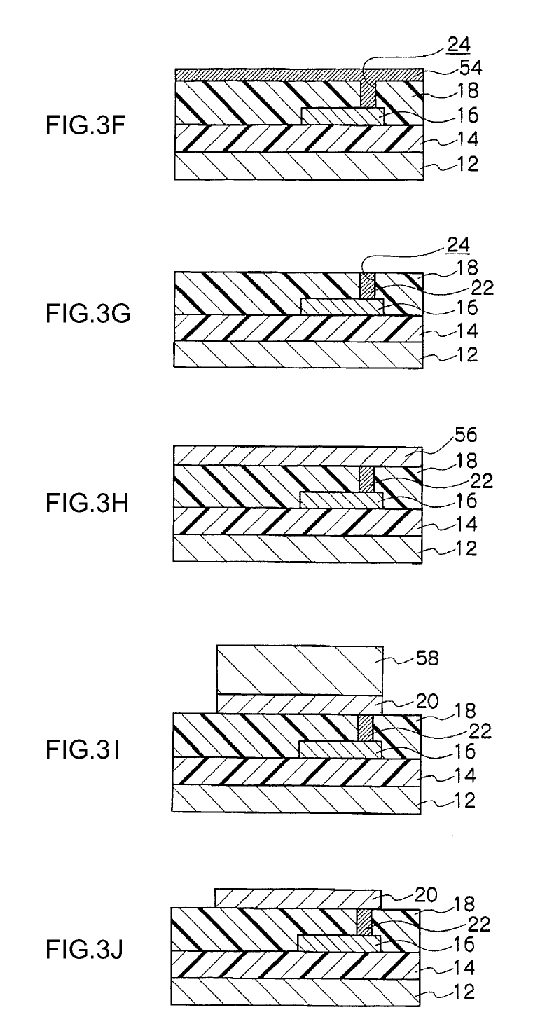

FIG. 3A to FIG. 3J are diagrams showing the method of manufacturing the current fuse pertaining to the first exemplary embodiment of the present invention.

First, as shown in FIG. 3A, the insulating layer 14 including a BPSG film or the like is formed by CVD or the like, for example, on the semiconductor substrate 12 such as a Si wafer.

Next, as shown in FIG. 3B, a conductive film 16A including AlSiCu or the like is formed by sputtering or the like, for example, on the insulating layer 14. Then, as shown in FIG. 3C, a photoresist 50 is applied or sprayed onto the surface of the conductive film 16A and is patterned by a photolithographic process, and the conductive film 16A is processed by a dry etching process to form the conductive portion 16. After this conductive portion 16 has been formed, the photoresist 50 on the conductive portion 16 is removed by a solvent or the like.

Next, as shown in FIG. 3D, the interlayer insulating layer 18 including a NSG film or the like, for example, is formed by CVD or the like, for example, on the insulating layer 14 and the conductive portion 16. Thereafter, as shown in FIG. 3E, a photoresist 52 is applied or sprayed onto the surface of the interlayer insulating layer 18 and is patterned by a photolithographic process, and the interlayer insulating layer 18 is processed by a dry etching process to form the hole 24. After this hole 24 has been formed, the photoresist 52 on the interlayer insulating layer 18 is removed by a solvent or the like.

Next, as shown in FIG. 3F, a conductive film 54 including copper or tungsten or the like is formed by sputtering or the like, for example, on the interlayer insulating layer 18, and some of the conductive film 54 is buried in the hole 24. After this conductive film 54 has been formed, as shown in FIG. 3G, the conductive film 54 except for the portion buried in the hole 24 is removed by a dry etching process to form the connecting portion 22 (through hole) in the hole 24.

Next, as shown in FIG. 3H, a conductive film 56 including AlSiCu or the like is formed by sputtering or the like, for example, on the interlayer insulating layer 18. Then, as shown in FIG. 3I, a photoresist 58 is applied or sprayed onto the surface of the conductive film 56 and is patterned by a photolithographic process, and the conductive film 56 is processed by a dry etching process to form the fuse portion 20.

After the fuse portion 20 has been formed, as shown in FIG. 3J, the photoresist 58 on the fuse portion 20 is removed by a solvent or the like. Finally, an insulating film (not shown) including a plasma nitride film or the like is formed by CVD or the like, for example, on the interlayer insulating film 18 and the fuse portion 20, a protective film (not shown) is formed by a photolithographic process and an etching process, and the fuse portion 20 is exposed.

The current fuse 10 shown in FIG. 1 and FIG. 2 is completed through the manufacturing process described above.

—Action (Method of Blowing Current Fuse)—

Next, the method of blowing the current fuse 10 pertaining to the first exemplary embodiment of the present invention will be described.

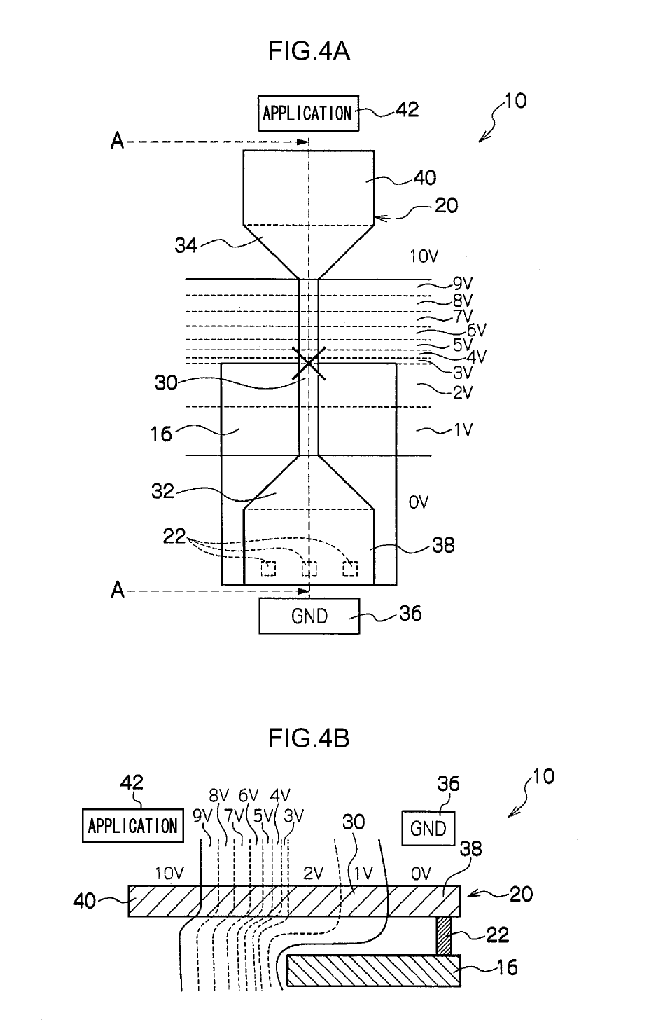

FIG. 4A and FIG. 4B are explanatory diagrams regarding the method of blowing the current fuse 10 pertaining to the first exemplary embodiment of the present invention, with FIG. 4A being a top view of the current fuse 10 pertaining to the first exemplary embodiment of the present invention and FIG. 4B being a sectional view as seen from line A-A of FIG. 4A. The lines showing voltages in the drawings are equipotential lines. In FIG. 4A and FIG. 4B, the substrate 12 and the interlayer insulating layer 18 and so forth are omitted.

First, in the current fuse 10 pertaining to the first exemplary embodiment of the present invention, a current is passed through the fuse portion 20. That is, the first terminal portion 38 is connected to the ground 36, and the second terminal portion 40 is connected to the applying portion 42. Then, a 10 V voltage is applied from the applying portion 42 to the second terminal portion 40. When this happens, a current flows through the fuse element 30 connected to the first terminal portion 38 and the second terminal portion 40, an electric field is generated, and the potential of the fuse element 30 becomes lower continuously from the second terminal portion 40 side toward the first terminal portion 38 side.

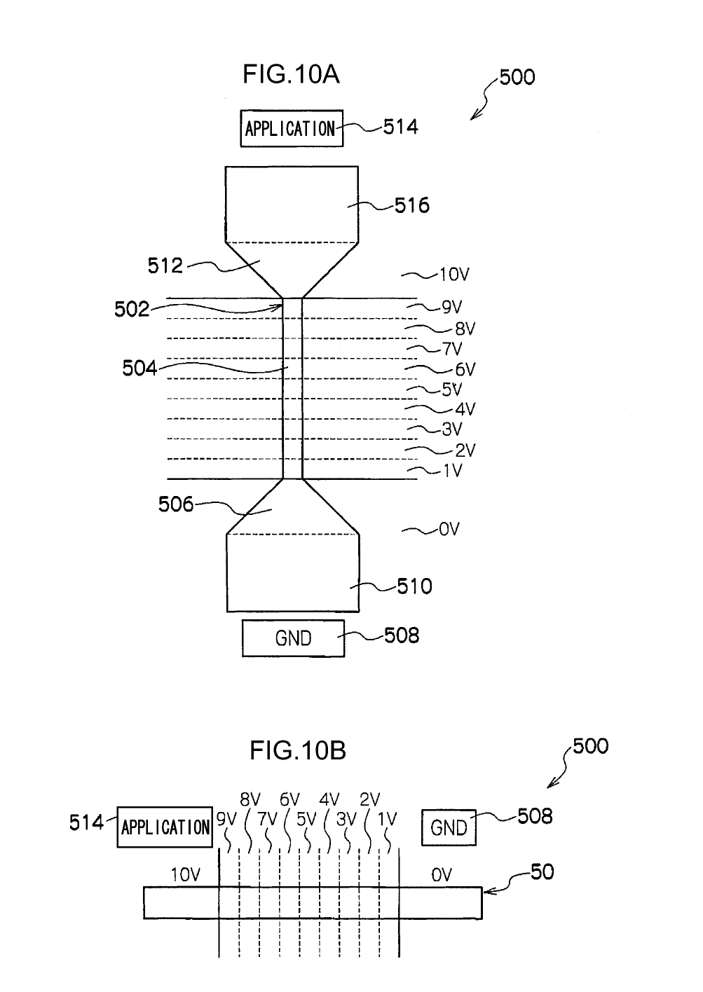

Here, in the conventional configuration, as shown in FIG. 10A and FIG. 10B, the equipotential lines in the fuse element 504 are formed at equal intervals and the electric field is made uniform. Consequently, the same Joule heat has been generated in all portions of the fuse element 504.

However, in the configuration of the first exemplary embodiment of the present invention, as shown in FIG. 4A and FIG. 4B, the conductive portion 16 that extends apart from the fuse portion 20 as far as the underlying layer below the midsection of the fuse element 30 is not electrically connected to the fuse portion 20 except for at the connecting portions 22, so the current does not flow through it, and the conductive portion 16 has the same potential (about 0 V) as that of the first terminal portion 38 to which it is electrically connected via the connecting portions 22. As a result of this, the equipotential lines are formed in avoidance of the conductive portion 16, and the electric field concentrates in the midsection of the fuse element 30 (the section marked by X in FIG. 4A). Additionally, with this configuration, when an overcurrent flows through the fuse portion 20, the current density becomes locally high and the Joule heat becomes higher at the midsection of the fuse element 30 where the electric field concentrates, and the fuse portion 20 can be easily blown (melted) at the midsection.

The phrase “the electric field concentrates” refers to the equipotential lines concentrating and the electric field becoming stronger.

Further, according to the configuration of the first exemplary embodiment of the present invention, the conductive portion 16 extends apart from the fuse portion 20 as far as the underlying layer below the midsection of the fuse element 30. For this reason, the electric field from the second terminal portion 40 side as far as the midsection of the fuse element 30 can be concentrated in the midsection. Thus, the fuse portion 20 can be more easily blown (melted) at the midsection.

Further, according to the configuration of the first exemplary embodiment of the present invention, the width of the fuse element 30 is narrower than the widths of both of the terminal portions 38 and 40. For this reason, the electric field becomes stronger in the fuse element 30 and the fuse portion 20 blows.

Further, the width of the conductive portion 16 is longer than the width of the fuse portion 20 and particularly the width of the fuse element 30. For this reason, it becomes possible to realize more reliable blowing of the fuse portion 20 because the electric field concentrates in the entire transverse width of the fuse portion 20 and particularly the fuse element 30.

Further, according to this configuration, the conductive portion 16 is placed is the underlying layer below the fuse portion 20, whereby it becomes possible to prevent a situation where, for example, an unillustrated open portion is disposed above the fuse portion 20 and, at the time when the fuse portion 20 blows, fragments and so forth of the blown fuse portion 20 fly inside a device to which the current fuse 10 is attached.

Further, because the interlayer insulating layer 18 is disposed between the fuse portion 20 and the conductive portion 16, the conductive portion 16 and the fuse portion 20 reliably no longer contact each other except for at the connecting portions 22.

Further, this current fuse 30 can also be effectively applied to a semiconductor device because it is equipped with the semiconductor substrate 12.

### Second Exemplary Embodiment

Next, a current fuse, a semiconductor device, and a method of blowing a current fuse pertaining to a second exemplary embodiment of the present invention will be described on the basis of the drawings. First, the structure of the current fuse pertaining to the second exemplary embodiment of the present invention will be described.

—Structure—

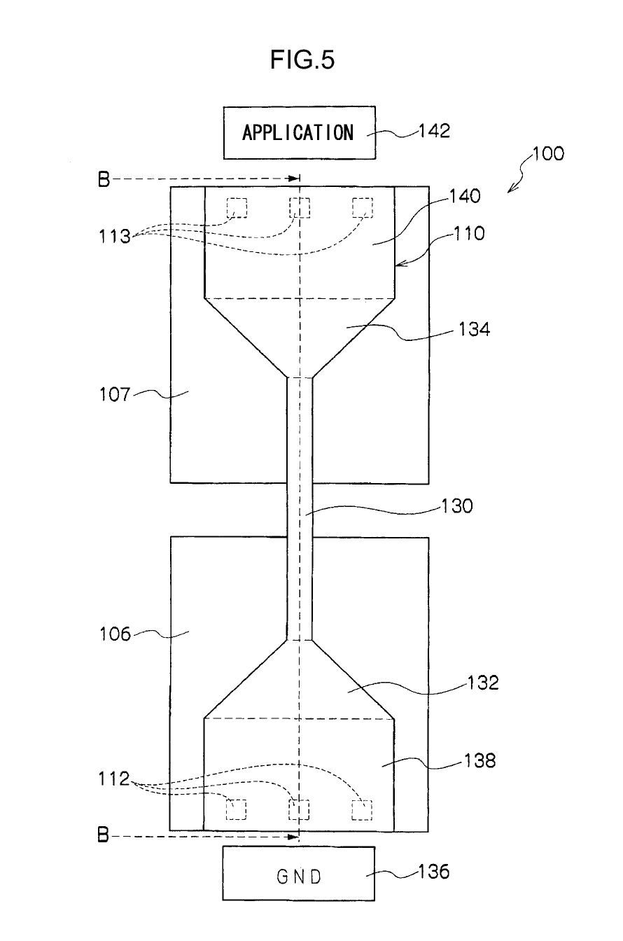

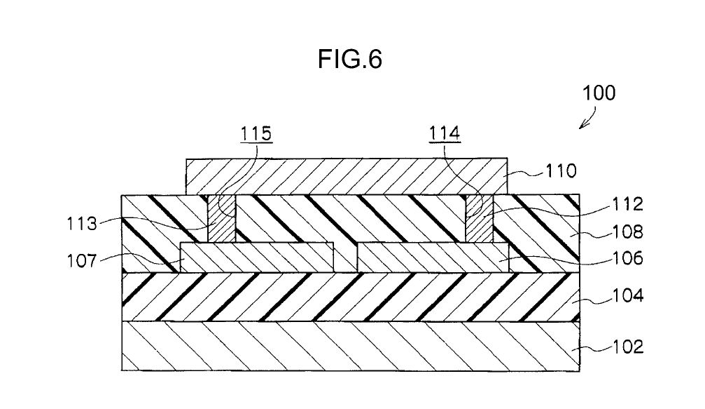

FIG. 5 is a general top view showing the structure of the current fuse pertaining to the second exemplary embodiment of the present invention, and FIG. 6 is a sectional view as seen from line B-B of FIG. 5.

As shown in FIG. 6, a current fuse 100 pertaining to the second exemplary embodiment of the present invention is configured in such a way that an insulating layer 104 including an insulator such as a BPSG (Boron Phosphor Silicate Glass) film, for example, is formed on a semiconductor substrate 102 such as a silicon wafer. Two conductive portions including a first conductive portion 106 and a second conductive portion 107 that are apart from and oppose each other in the same layer are formed on this insulating layer 104.

The conductive portions 106 and 107 includes a conductor such as AlSiCu, for example, and their upper surfaces are covered by an interlayer insulating layer 108 similarly formed on the insulating layer 104. This interlayer insulating layer 108 includes a NSG (Non-doped Silicate Glass) film or a plasma oxide film or the like, for example, and a fuse portion 110 is formed on the interlayer insulating layer 108.

This fuse portion 110 includes a conductor such as AlSiCu like both of the conductive portions 106 and 107, for example, and one end portion of the first conductive portion 106 and one end portion of the fuse portion 110 are electrically interconnected via a first connecting portion 112. Further, one end portion of the second conductive portion 107 and the other end portion of the fuse portion 110 are electrically interconnected via a second connecting portion 113. Both of the connecting portions 112 and 113 are so-called through holes including a conductor such as copper or tungsten buried inside holes 114 and 115 penetrating the interlayer insulating layer 108.

A protective layer including an insulator such as a plasma nitride film, for example, is disposed on the interlayer insulating layer 108 so as to cover the area surrounding the fuse portion 110, but the protective layer is omitted throughout all the drawings.

Next, the configurations of the fuse portion 110 and the conductive portions 106 and 107 will be specifically described using FIG. 5. In FIG. 5, the substrate 102 and the interlayer insulating layer 108 and so forth are omitted.

The fuse portion 110 has a fuse element 130 that melts when an overcurrent flows through it. This fuse element 130 has a slender rectangular shape when seen in a top view. The length of the fuse element 130 in its lengthwise direction is 10 μm, for example, and the length (width) of the fuse element 130 in its widthwise direction is 1.2 μm, for example.

Additionally, a first joint portion 132 is connected to one lengthwise direction end portion of the fuse element 130. Further, a second joint portion 134 is connected to the other lengthwise direction end portion of the fuse element 130. The first joint portion 132 and the second joint portion 134 (called “both of the joint portions” below) have trapezoidal shapes when seen in a top view and slant by 45 degrees toward the fuse element 130 side such that their widths gradually become narrower.

The first joint portion 132 is connected to a first terminal portion 138 electrically connected to a ground 136 and joins together the fuse element 130 and the first terminal portion 138. Further, the second joint portion 134 is connected to a second terminal portion 140 electrically connected to an applying portion 142 that applies a 10 V voltage, for example, and the second joint portion 134 joins together the fuse element 130 and the second terminal portion 140.

The widths of the first terminal portion 138 and the second terminal portion 140 (called “both of the terminal portions” below) are 6 μm, for example, and are wider than the width of the fuse element 130.

One end portion each of three, for example, of the first connecting portions 112 are arranged in the width direction an interval apart from each other and contact the lower surface of the first terminal portion 138.

Each of the first connecting portions 112 extends linearly downward from the lower surface of the first terminal portion 138 of the fuse portion 110, and the other end portion of each of the first connecting portions 112 contacts the upper surface of the aforementioned first conductive portion 106. The first conductive portion 106 is placed in an underlying layer below the fuse portion 110 with the interlayer insulating layer 108 being sandwiched therebetween, has the same potential (about 0 V) as that of one portion of the fuse portion 110 (the portion of the fuse portion 110 that contacts the first connecting portions 112) when a current is passed through the fuse portion 110, and extends from the one portion side of the fuse portion 110 as far as an underlying layer below another portion of the fuse portion 110 whose potential differs from that of the one portion.

Specifically, in the second exemplary embodiment, the other portion is the fore of an intermediate section of the fuse element 130—such as, for example, a midsection of the fuse element 130—whose potential is higher than that of the one portion of the fuse portion 110, and the first conductive portion 106 extends apart from the fuse portion 110 linearly from the underlying layer below the portion of the fuse portion 110 that contacts the first connecting portions 112 as far as the underlying layer below the fore of the midsection of the fuse element 130.

One end portion each of three, for example, of the second connecting portions 113 are arranged in the width direction an interval apart from each other and contact the lower surface of the second terminal portion 140.

Each of the second connecting portions 113 extends linearly downward from the lower surface of the second terminal portion 140 of the fuse portion 110, and the other end portion of each of the second connecting portions 113 contacts the upper surface of the aforementioned second conductive portion 107. The second conductive portion 107 is placed in an underlying layer below the fuse portion 110 with the interlayer insulating layer 108 being sandwiched therebetween and has the same potential (about 10 V) as that of the portion of the second terminal portion 140 that contacts the second connecting portions 112.

Further, the second conductive portion 107 extends apart from the fuse portion 110 linearly from the second terminal portion 140 side toward the first terminal portion side 138, and is apart from and opposes the first conductive portion 106 in the underlying layer below the midsection of the fuse element 130.

—Manufacturing Method—

Next, a method of manufacturing the current fuse pertaining to the second exemplary embodiment of the present invention will be described.

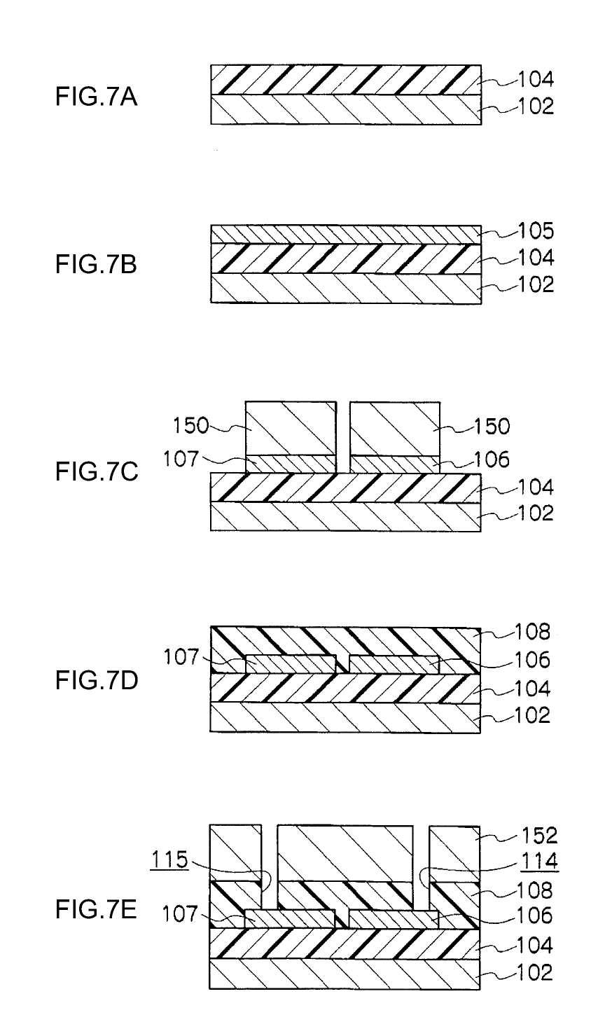

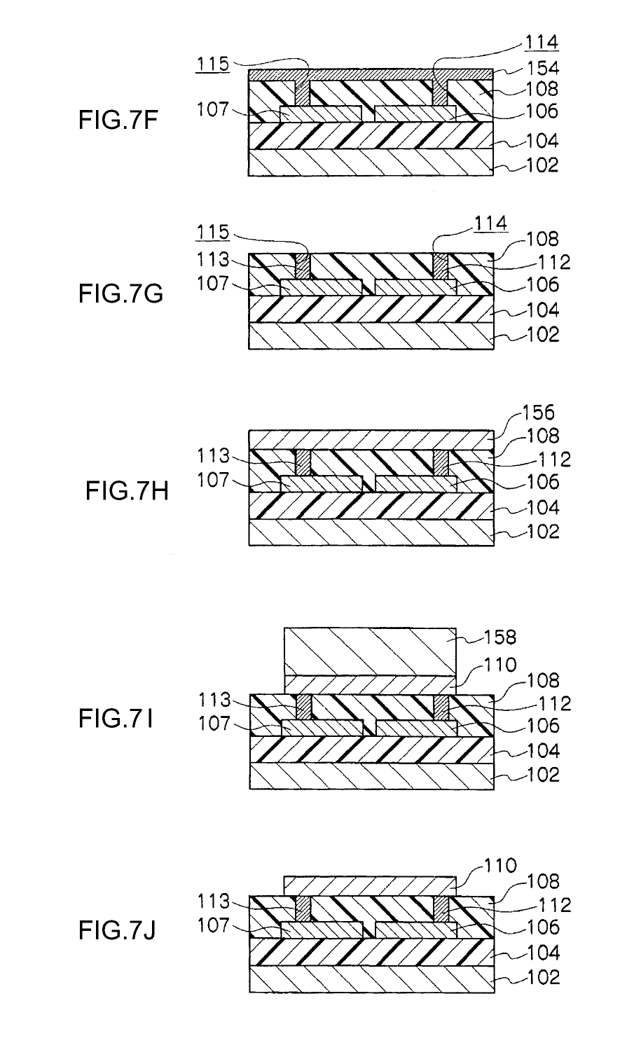

FIG. 7A to FIG. 7J are diagrams showing the method of manufacturing the current fuse pertaining to the second exemplary embodiment of the present invention.

First, as shown in FIG. 7A, the insulating layer 104 including a BPSG film or the like is formed by CVD or the like, for example, on the semiconductor substrate 102 such as a Si wafer.

Next, as shown in FIG. 7B, a conductive film 105 including AlSiCu or the like is formed by sputtering or the like, for example, on the insulating layer 104. Then, as shown in FIG. 7C, a photoresist 150 is applied or sprayed onto the surface of the conductive film 105 and is patterned by a photolithographic process, and the conductive film 105 is processed by a dry etching process to form the first conductive portion 106 and the second conductive portion 107. After both of the conductive portions 106 and 107 have been formed, the photoresist 150 on both of the conductive portions 106 and 107 is removed by a solvent or the like.

Next, as shown in FIG. 7D, the interlayer insulating layer 108 including a NSG film or the like, for example, is formed by CVD or the like, for example, on the insulating layer 104 and both of the conductive portions 106 and 107. Thereafter, as shown in FIG. 7E, a photoresist 152 is applied or sprayed onto the surface of the interlayer insulating layer 108 and is patterned by a photolithographic process, and the interlayer insulating layer 108 is processed by a dry etching process to form the holes 114 and 115. After these holes 114 and 115 have been formed, the photoresist 152 on the interlayer insulating layer 108 is removed by a solvent or the like.

Next, as shown in FIG. 7F, a conductive film 154 including copper or tungsten or the like is formed by sputtering or the like, for example, on the interlayer insulating layer 108, and some of the conductive film 154 is buried in the holes 114 and 115. After this conductive film 154 has been formed, as shown in FIG. 7G the conductive film 154 except for the portions buried in the holes 114 and 115 is removed by a dry etching process to form the first connecting portion 112 and the second connecting portion 113 (through holes) in the holes 114 and 115.

Next, as shown in FIG. 7H, a conductive film 156 including AlSiCu or the like is formed by sputtering or the like, for example, on the interlayer insulating layer 108. Then, as shown in FIG. 7I, a photoresist 158 is applied or sprayed onto the surface of the conductive film 156 and is patterned by a photolithographic process, and the conductive film 156 is processed by a dry etching process to form the fuse portion 110.

After the fuse portion 110 has been formed, as shown in FIG. 7J, the photoresist 158 on the fuse portion 110 is removed by a solvent or the like. Finally, an insulating film (not shown) including a plasma nitride film or the like is formed by CVD or the like, for example, on the interlayer insulating film 108 and the fuse portion 110, a protective film (not shown) is formed by a photolithographic process and an etching process, and the fuse portion 110 is exposed.

The current fuse 100 shown in FIG. 5 and FIG. 6 is completed through the manufacturing process described above.

—Action (Method of Blowing Current Fuse)—

Next, the method of blowing the current fuse 100 pertaining to the second exemplary embodiment of the present invention will be described.

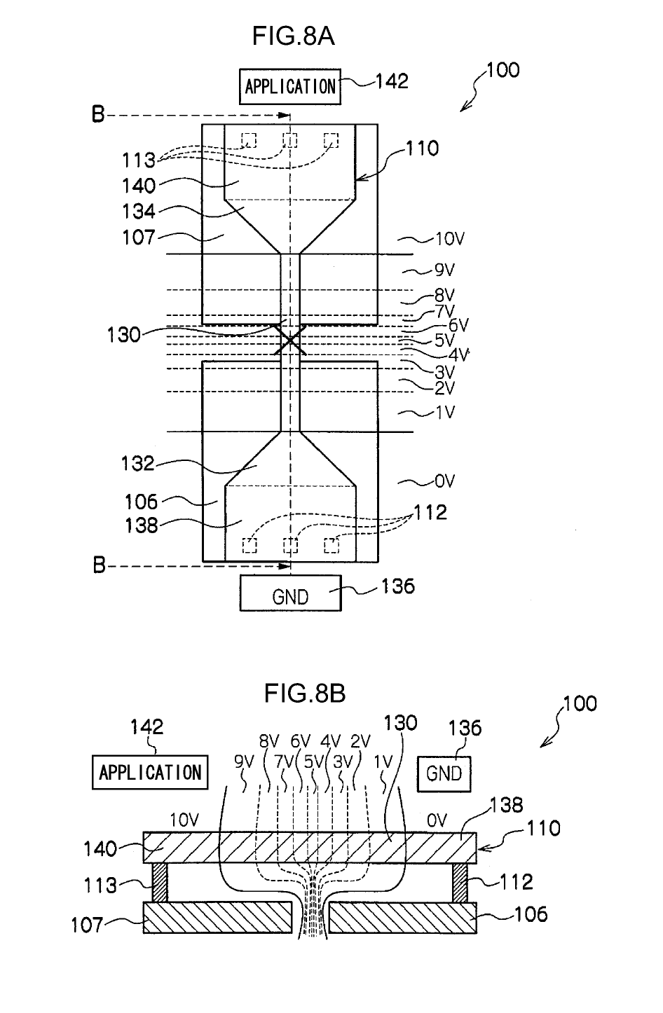

FIG. 8A and FIG. 8B are explanatory diagrams regarding the method of blowing the current fuse 100 pertaining to the second exemplary embodiment of the present invention, with FIG. 8A being a top view of the current fuse 100 pertaining to the second exemplary embodiment of the present invention and FIG. 8B being a sectional view as seen from line B-B of FIG. 8A. The lines showing voltages in the drawings are equipotential lines. In FIG. 8A and FIG. 8B, the substrate 102 and the interlayer insulating layer 108 and so forth are omitted.

First, in the current fuse 100 pertaining to the second exemplary embodiment of the present invention, a current is passed through the fuse portion 110. That is, the first terminal portion 138 is connected to the ground 136, and the second terminal portion 140 is connected to the applying portion 142. Then, a 10 V voltage is applied from the applying portion 142 to the second terminal portion 140. When this happens, a current flows through the fuse element 130 connected to the first terminal portion 138 and the second terminal portion 140, an electric field is generated, and the potential of the fuse element 130 becomes lower continuously from the second terminal portion 140 side toward the first terminal portion 138 side.

Here, in the configuration of the second exemplary embodiment of the present invention, as shown in FIG. 8A and FIG. 8B, the first conductive portion 106 that extends apart from the fuse portion 110 as far as the underlying layer below the fore of the midsection of the fuse element 130 is not electrically connected to the fuse portion 110 except for at the first connecting portions 112. For this reason, the current does not flow through it, and the first conductive portion 106 has the same potential (about 0 V) as that of the first terminal portion 138 to which it is electrically connected via the first connecting portions 112. Similarly, the second conductive portion 107 that opposes the first conductive portion 106 an interval apart from the first conductive portion 106 is not electrically connected to the fuse portion 110 except for at the second connecting portions 113. For this reason, the current does not flow through it, and the second conductive portion 107 has the same potential (about 10 V) as that of the second terminal portion 140 to which it is electrically connected via the second connecting portions 113.

As a result of this, the equipotential lines are formed in avoidance of the first conductive portion 106 and the second conductive portion 107. Thus, the electric field concentrates in the fuse element 130 located in the overlying layer above the gap formed between the first conductive portion 106 and the second conductive portion 107—that is, in the midsection (the section marked by X in FIG. 8A) of the fuse element 130. Additionally, with this configuration, when an overcurrent flows through the fuse portion 110, the current density becomes locally high and the Joule heat becomes higher at the midsection of the fuse element 130 where the electric field concentrates, and the fuse portion 110 can be easily blown (melted) at the midsection.

Additionally, in the configuration of the second exemplary embodiment, as compared to the first exemplary embodiment, the second conductive portion 107 is disposed, whereby it becomes possible to blow the fuse portion 110 reliably because the electric field can be concentrated more locally in the fuse element 130.

### Third Exemplary Embodiment

Next, a current fuse, a semiconductor device, and a method of blowing a current fuse pertaining to a third exemplary embodiment of the present invention will be described on the basis of the drawings.

—Structure—

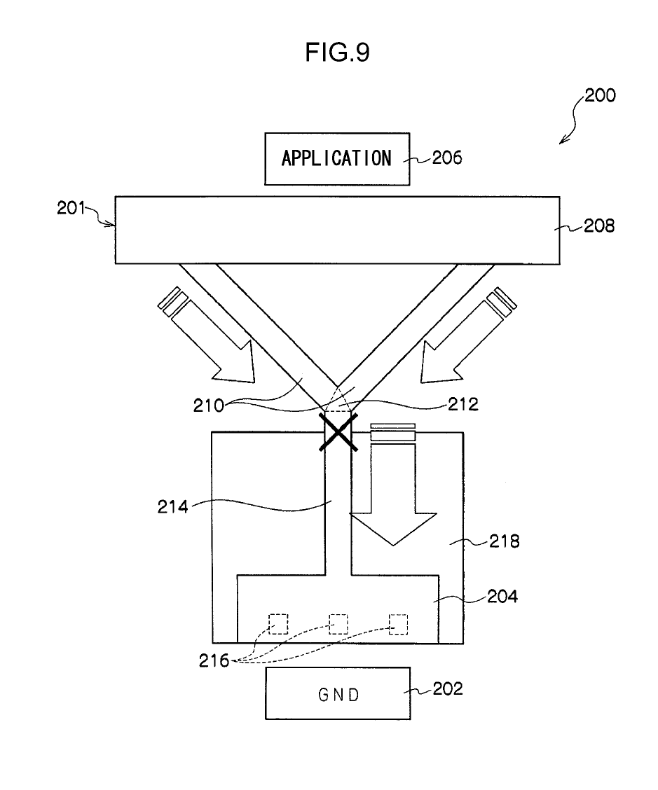

FIG. 9 is a general top view showing the structure of the current fuse pertaining to the third exemplary embodiment of the present invention. In FIG. 9, the substrate and the interlayer insulating layer and so forth are omitted.

A current fuse 200 pertaining to the third exemplary embodiment of the present invention is equipped with a fuse portion 201 on an unillustrated semiconductor substrate. Like in the first exemplary embodiment, this fuse portion 201 has a first terminal portion 204 connected to a ground 202 and a second terminal portion 208 connected to an applying portion 206. However, in the third exemplary embodiment, the configuration of the fuse element connected to the first terminal portion 204 and the second terminal portion 208 differs from that in the first exemplary embodiment.

That is, in the third exemplary embodiment, the fuse element connected to the first terminal portion 204 and the second terminal portion 208 has two first fuse elements 210 that are connected to respectively different places of the second terminal portion 208 and extend from the second terminal portion 208 toward the first terminal portion 204, a joint portion 212 at which the two first fuse elements 210 join together, and a second fuse element 214 that extends from the joint portion 212 to the first terminal portion 204.

Further, one end portion each of three, for example, connecting portions 216 are arranged in the width direction an interval apart from each other and contact the lower surface of the first terminal portion 104.

Each of the connecting portions 216 extends linearly downward from the lower surface of the first terminal portion 204 of the fuse portion 201, and the other end portion of each of the connecting portions 216 contacts the upper surface of a conductive portion 218. The conductive portion 208 is placed in an underlying layer below the fuse portion 201 with the unillustrated interlayer insulating layer being sandwiched therebetween, has the same potential (about 0 V) as that of one portion of the fuse portion 201 (the portion of the fuse portion 201 that contacts the connecting portions 216) when a current is passed through the fuse portion 201, and extends from the one portion side of the fuse portion 201 as far as an underlying layer below another portion of the fuse portion 201 whose potential differs from that of the one portion.

Specifically, in the third exemplary embodiment, the other portion is an intermediate section of the second fuse element 214—such as, for example, the section of the fuse element just before the joint portion 212—whose potential is higher than that of the one portion of the fuse portion 201, and the conductive portion 218 extends apart from the fuse portion 201 linearly from the underlying layer below the portion of the fuse portion 201 that contacts the connecting portions 216 as far as the underlying layer just before the second fuse element 214.

—Action (Method of Blowing Current Fuse)—

As described above, according to the configuration of the current fuse pertaining to the third exemplary embodiment of the present invention, in a case where the same amount of current flows through the two first fuse elements 210 connected to different places of the second terminal portion 208, about twice the current flows through the second fuse element 214 from the joint portion 212 to the first terminal portion 204 as compared to each of the first fuse elements 210, and the electric field concentrates in the second fuse element 214 (the current density becomes larger). Further, because the conductive portion 218 extends apart from the fuse portion 201 as far as the underlying layer just before the joint portion 212 of the second fuse element 214, the electric field further concentrates in the section just before the joint portion 212 of the second fuse element 214 through which about twice the current flows as compared to each of the first fuse elements 210. Consequently, the fuse portion 201 can be more easily blown at the section just before the joint portion 212 of the second fuse element 214.

(Modifications)

The present invention is not limited to the exemplary embodiments described above and is capable of various modifications, changes, and improvements.

For example, in the exemplary embodiments described above, cases where the current fuses 10, 100, and 200 are formed on the semiconductor substrates 12 and 102 have been described. However, these may also be formed on a glass substrate, a plastic substrate, a ceramic substrate, a polyimide substrate, etc. Further, the shape of the substrate is also not particularly limited, and it suffices for the substrate to be a so-called substrate serving as a foundation on which the fuse is formed.

Further, cases where a protective film is disposed have been described, but the present invention can also be applied to a current fuse in which a protective film is not disposed.

Further, the current fuses 10, 100, and 200 described above can be applied to a semiconductor device.

Further, cases where the conductive portion 16, the first conductive portion 106, the second conductive portion 107, and the conductive portion 218 are disposed in an underlying layer below the fuse portions 20, 110, and 201 have been described, but the conductive portions may also be disposed in an overlying layer above the fuse portions 20, 110, and 201. However, it is preferable to dispose the conductive portion in an underlying layer below the fuse portion so that it is possible to prevent, at the time when the fuse portions 20, 110, and 210 blow, fragments and so forth of the blown fuse portions 20, 110, and 210 from flying inside devices to which the current fuses 10, 100, and 200 are attached.

Further, in the third exemplary embodiment, the current fuse may also have a configuration that does not have the conductive portion 218. That is, in a case where the same amount of current flows through the two first fuse elements 210 connected to different places of the second terminal portion 208, about twice the current flows through the second fuse element 214 from the joint portion 212 to the first terminal portion 204 as compared to each of the first fuse elements 210, and the electric field concentrates in the second fuse element 214 (the current density becomes larger), so the fuse portion 201 can be more easily blown even with just the configuration of the fuse portion 201.

Further, in the first exemplary embodiment, a case where the conductive portion 16 is electrically connected to the fuse portion 20 via the connecting portions 22 has been described, but the current fuse may also have a configuration where, for example, the conductive portion 16 is connected to the ground 36 and is not connected to the fuse portion 20. In this case, the connecting portions 22 are unnecessary. Moreover, the connecting portions 22 may also be connected to the fuse portion 20 other than at the first terminal portion 38. Consequently, they may also be connected to the second terminal portion 40 or the fuse element 30. In a case where the connecting portions 22 are connected to the second terminal portion 40, the conductive portion 16 extends from the second terminal portion 40 side toward the first terminal portion 38 side.

Further, a case where the width of the fuse element 30 is narrower than the widths of both of the terminal portions 38 and 40 has been described, but the width of the fuse element 30 does not have to be narrower than the widths of both terminal portions 38 and 40. However, it is preferable for the width of the fuse element 30 to be narrower than the widths of both of the terminal portions 38 and 40.

What is claimed is:

1. A current fuse comprising:
a fuse portion that is disposed on a substrate; and
a conductive portion that is placed in an overlying layer above the fuse portion or an underlying layer between the substrate and the fuse portion, has the same potential as that of one portion of the fuse portion when a current is passed through the fuse portion, and extends apart from the fuse portion from the one portion side of the fuse portion as far as an overlying layer above or an underlying layer below another portion of the fuse portion whose potential differs from that of the one portion.

2. The current fuse according to claim 1, further comprising a connecting portion that extends from the one portion of the fuse portion to the overlying layer or the underlying layer and electrically interconnects the one portion of the fuse portion and the conductive portion.

3. The current fuse according to claim 1, wherein the other portion of the fuse portion has a higher potential than that of the one portion of the fuse portion.

4. The current fuse according to claim 3, wherein
the fuse portion has a first terminal portion on a ground side, a second terminal portion on an applying side, and a fuse element connected to both of the terminal portions,
the connecting portion is connected to the first terminal portion, and
the conductive portion extends from the first terminal portion side as far as an overlying layer above or an underlying layer below an intermediate section of the fuse element.

5. The current fuse according to claim 4, wherein the conductive portion extends as far as the overlying layer above or the underlying layer below a midsection of the fuse element.

6. The current fuse according to claim 2, wherein
the fuse portion has a first terminal portion on a ground side, a second terminal portion on an applying side, and a fuse element connected to both of the terminal portions,
the connecting portion has a first connecting portion connected to the first terminal portion and a second connecting portion connected to the second terminal portion, and
the conductive portion has
a first conductive portion that is electrically connected to the fuse portion via the first connecting portion and extends from the first terminal portion side as far as an overlying layer above or an underlying layer below an intermediate section of the fuse element and
a second conductive portion that is electrically connected to the fuse portion via the second connecting portion, extends from the second terminal portion side toward the first terminal portion side, and is apart from and opposes the first conductive portion.

7. A current fuse comprising:
a fuse portion that is disposed on a substrate and is configured to include a first terminal portion on a ground side, a second terminal portion on an applying side, and a fuse element connected to both of the terminal portions; and
a conductive portion that is placed in an overlying layer above the fuse portion or an underlying layer between the substrate and the fuse portion, is electrically connected to the first terminal portion, and extends apart from the fuse portion from the first terminal portion side as far as an overlying layer above or an underlying layer below an intermediate section of the fuse element.

8. The current fuse according to claim 4, wherein the width of the fuse element is narrower than the widths of both of the terminal portions.

9. The current fuse according to claim 7, wherein the width of the fuse element is narrower than the widths of both of the terminal portions.

10. The current fuse according to claim 4, wherein the width of the conductive portion is longer than the width of the fuse element.

11. The current fuse according to claim 7, wherein the width of the conductive portion is longer than the width of the fuse element.

12. The current fuse according to claim 4, wherein
the fuse element has two first fuse elements that are connected to respectively different places of the second terminal portion serving as the applying side and extend from the second terminal portion toward the first terminal portion, a joint portion at which the two first fuse elements join together, and a second fuse element that extends from the joint portion to the first terminal portion, and
the conductive portion electrically connected to the first terminal portion extends as far as an overlying layer above or an underlying layer below an intermediate section of the second fuse element.

13. The current fuse according to claim 7, wherein
the fuse element has two first fuse elements that are connected to respectively different places of the second terminal portion serving as the applying side and extend from the second terminal portion toward the first terminal portion, a joint portion at which the two first fuse elements join together, and a second fuse element that extends from the joint portion to the first terminal portion, and
the conductive portion electrically connected to the first terminal portion extends as far as an overlying layer above or an underlying layer below an intermediate section of the second fuse element.

14. The current fuse according to claim 2, wherein
an interlayer insulating layer is disposed between the fuse portion and the conductive portion,
the connecting portion comprises a conductor buried inside a hole penetrating the interlayer insulating layer, and
the conductive portion is placed in an underlying layer below the fuse portion.

15. The current fuse according to claim 7,
an interlayer insulating layer is disposed between the fuse portion and the conductive portion,
a connecting portion between the conductive portion and the first terminal portion comprises a conductor buried inside a hole penetrating the interlayer insulating layer, and
the conductive portion is placed in an underlying layer below the fuse portion.

16. A semiconductor device comprising:
a semiconductor substrate;
an insulating layer that is formed on the semiconductor substrate; and
the current fuse according to claim 1 which is formed on the insulating layer.

17. A semiconductor device comprising:
a semiconductor substrate;
an insulating layer that is formed on the semiconductor substrate; and
the current fuse according to claim 7 which is formed on the insulating layer.

18. A method of blowing a current fuse where a fuse portion is disposed on a substrate, the method comprising placing a conductive portion having a single potential apart from the fuse portion in an overlying layer above the fuse portion or an underlying layer between the substrate and the fuse portion and utilizing the conductive portion to concentrate an electric field in one portion of the fuse portion and melt the fuse portion.

19. The method of blowing a current fuse according to claim 18, wherein
the fuse portion has a first terminal portion on a ground side, a second terminal portion on an applying side, and a fuse element connected to both of the terminal portions, and
as the conductive portion, the method uses
a first conductive portion that is electrically connected to the fuse portion via a first connecting portion connected to the first terminal portion and extends from the first terminal portion side as far as an overlying layer above or an underlying layer below an intermediate section of the fuse element and
a second conductive portion that is electrically connected to the fuse portion via a second connecting portion connected to the second terminal portion, extends from the second terminal portion side toward the first terminal portion side, and is apart from and opposes the first conductive portion.
